(19) United States
(12) Patent Application Publication
(10) Pub. No.: US 2011/0055048 A1
(43) Pub. Date: Mar. 3, 2011

(54) Book purchasing system with filters and continuous loop execution

(75) Inventors: Woodlee T. Hunt, Alamo, CA (US); Alessandro Belardinelli, San Francisco, CA (US); Luca Michelini, Berkeley, CA (US)

(73) Assignee: Woody's Book, Inc., Martinez, CA (US)

(21) Appl. No.: 12/806,873

(22) Filed: Aug. 23, 2010

Related U.S. Application Data
(60) Provisional application No. 61/237,269, filed on Aug. 26, 2009.

(51) Int. Cl. G06Q 30/00

(52) U.S. Cl. 705/26.63

(57) ABSTRACT

A book purchasing system allows a book buyer to log onto the system via a Web interface and purchase books from one or more book-selling venues. The buyer enters information on the books he wants to purchase and criteria relating to the purchases. The system searches the venues for listings matching this information. The listings are filtered using the other criteria entered by the buyer. These filtered listings may be displayed to the buyer and the buyer may then select which listings to execute to meet his purchasing needs. Once selected, the buyer can execute the listings at the venue. The system may automatically complete the transactions at the venues on behalf of the buyer. The system may continuously search the venues for listings that match the buyer criteria and will continue searching until listings are identified or the buyer manually stops the search.

### CROSS-REFERENCE TO RELATED APPLICATION

This application claims the benefit of priority under 35 U.S.C. §119 of U.S. Provisional Patent Application No. 61/237,269, titled “Automated Volume Book Purchasing System and Method,” filed Aug. 26, 2009, which is hereby incorporated by reference in its entirety and for all purposes.

### BACKGROUND OF THE INVENTION

1. Field of the Invention

The present invention relates generally to computer software and computer network applications. More specifically, the invention relates to a computer system for executing automated transactions for purchasing books over a computer network.

2. Description of Related Art

Consumers who want to purchase books from Web sites currently have tools that facilitate the process. One type of tool is the price comparison engine. The buyer enters information on one book and the engine searches multiple Web sites to find the lowest price and returns the information to the buyer, who can then go to the Web site to purchase the book. However, such tools fall short when the buyer is attempting to buy many different books and large volumes of each.

For example, an individual who wants to buy a single book online can use a price comparison tool to find the Web site offering the lowest price. The individual can do this for multiple books, although information for each book must typically be entered one at a time.

Although this is not an overly tedious process when buying a few books over the Internet and the buyer does not have a need to specify numerous (other than condition) criteria regarding the book. However, take a buyer, such as a university or a chain bookstore, which wants to buy 150 different books (titles) and wants 800 copies of each at the lowest price possible or 2,000 copies of 500 different books. In these scenarios, clearly a price comparison engine and most other book buying tools currently available are not at all well suited to facilitate making such a purchase.

Furthermore, suppose the buyer wants to streamline the buying process as much as possible; that is, make it efficient and less error-prone, and has some very specific criteria that must be met when making the purchase. Naturally, the buyer does not want to repeatedly go to all the various book-selling Web sites, such as numerous Amazon sites or the Barnes & Noble site (to name just a few out of dozens of such sites), to find the volume and prices he is looking for and then have to make each individual purchase. For large volumes of many different books, potentially available at a dozen different Web sites (marketplaces), the buyer may have to make many individual transactions over many different sites. Clearly, this can be very time-consuming and can expose the buyer to errors and miscommunications with different parties. Currently, there are no tools or applications available that allows the buyer to find the best prices for making such large volume purchases and meet very specific criteria or filters. The number of such buyers is growing, as more entities, such as textbook stores, trade book stores, libraries, online sellers, wholesalers, and chain bookstores, are all turning to Internet applications to help them with making large-volume purchases.

Therefore, it would be desirable to have applications that enabled a buyer to streamline the process of purchasing large volumes of multiple books over the Internet. It would also be desirable if such applications facilitated finding the prices specified by the buyer for each of the multiple books and allowed it to set other filters or criteria as parameters for each of the purchases. It would also be desirable to have applications that complete the actual purchasing of the books on behalf of the buyer.

### SUMMARY OF THE INVENTION

A book purchasing system allows a user or book buyer to log onto the system via a Web interface and purchase books from one or more book-selling venues. The buyer enters information on the books he wants to purchase and criteria relating to the purchases. The system creates a buying list based on a subset of this information, such as ISBN and maximum price the buyer is willing to pay. It searches the venues (e.g., Amazon.com, BN.com, Half.com) for listings matching this information and stores the listings. The listings are filtered using the other criteria entered by the buyer, such as condition, venue, seller reputation, and so on. For example, the buyer may specify that purchases be made only at certain venues.

In one embodiment, these filtered listings are displayed to the buyer and the buyer may then select which listings to execute to meet his purchasing needs. Once selected, the buyer can execute the listings at the venue where the shopping cart for a venue is already filled by the book purchasing system. The buyer may then complete the checkout process at the venue himself. In another embodiment, the system may automatically complete the transactions at the venues on behalf of the buyer. In another embodiment, the system continuously searches the venues for listings that match the buyer criteria and will continue searching until listings are indentified or the buyer manually stops the search. The buyer's purchasing history may also be examined during the continuous loop searching such that if the buyer has purchased the maximum quantity desired, the system will stop searching. In all these embodiments, the buyer is able to buy books meeting specific criteria from multiple venues at the price he wants by using one system.

### BRIEF DESCRIPTION OF THE DRAWINGS

References are made to the accompanying drawings, which form a part of the description and in which are shown, by way of illustration, particular embodiments:

FIG. 1 is a network diagram showing a broad overview of the parties relevant to the present invention;

FIG. 2 is a block diagram showing various components and modules in book selling service provider system in accordance with one embodiment;

FIG. 3 is a screen diagram showing a “bad sellers” filter user interface screen in accordance with one embodiment;

FIG. 4 is a screen diagram of a seller mapping user interface screen in accordance with one embodiment;

FIG. 5 is an overview flow diagram of a process for buying books using services from the service provider in accordance with one embodiment;

FIG. 6 is a block diagram showing a unique identifier used in the book purchasing system of the present invention;

FIG. 7 is a block diagram showing a data storage component storing tables relevant to the implementation of the book purchasing system of the present invention;

FIG. 8 is a flow diagram showing a process of creating and fulfilling a buying list as executed by the service provider's system in accordance with one embodiment;

FIG. 9 is a screen diagram of a global filters screen that a buyer can use to set filters in accordance with one embodiment; and

FIGS. 10A and 10B show one physical implementation of a computing system for implementing the book purchasing system of the present invention.

### DETAILED DESCRIPTION OF THE INVENTION

Example embodiments of an online book buying system according to the present invention are described. These examples and embodiments are provided solely to add context and aid in the understanding of the invention. Thus, it will be apparent to one skilled in the art that the present invention may be practiced without some or all of the specific details described herein. In other instances, well-known concepts and online application components and technologies have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for purchasing books over the Internet are described in the various figures. Embodiments of the present invention allow a buyer to buy large volumes of multiple books from different marketplaces or venues on the Internet. Book stores and libraries, for example, are buying books online to use and/or resell in their local brick and mortar establishments. The present invention allows these organizations to purchase books more efficiently online by searching thousands of sellers across several major marketplaces (also referred to as venues) at once. Examples of marketplaces include Amazon.com, Barnes and Noble's Web site (bn.com), Abebooks, half.com (an eBay company), alibris, and others. These venues sell new copies of books as well as used copies from third-party sellers. Thus, when buying a book, the marketplace may offer a new copy of the book at a certain price and used copies at other prices, typically lower than the new book price. The used copies are sold by sellers (not the marketplace itself) who use the marketplace as a place to sell their used (or new) books. These third-party sellers may develop a good or poor reputation over time. The marketplace manages the transaction between the buyer and the third-party seller. For example, it manages the payment made by the buyer, it can reverse a transaction, force the seller to refund a purchase, or freeze funds if there are claims or disputes.

Before describing the various embodiments, it is useful to provide some examples or scenarios of how the present invention may be used by a book buyer. For the purpose of illustrating the various embodiments, we assume that a book buyer is in the market for many different books at large volumes. Of course, the concepts and features of the present invention are equally applicable to buyers buying only a few books or even one book. In one example, a book buyer, such as a chain bookstore or a university textbook store, wants to make the following purchases: 1,800 copies of Book X; 5,000 copies of Book Y, and 4,300 copies of Book Z. Each book (or title) has an ISBN number, typically 13 digits, which is used to uniquely identify a book. The buyer has set the following criteria: each copy must be in at least “Acceptable” condition; each third-party seller (from whom a book may be purchased) must have a minimum rating of 80%; and no books may be bought from third-party sellers A, B, and C. In addition, the purchases may only be made at marketplaces L, M, N, and O; books may not be bought at any other venues. The maximum price the buyer will pay for Book X is $14.50, for Book Y is $7.80, and for Book Z is $21.30. These are simply a few examples of the filters that a buyer can set. Methods and systems of the present invention allow a buyer to create a buying list specifying these criteria. When submitted to the book buying system of the present invention, the system will return information meeting these criteria and pricing information to the buyer, who can then select which transactions to make. The buyer can then select which ones to buy and have the purchases made automatically by the system.

In another example, a book buyer wants to buy 250 different books (250 different ISBNs) and wants a maximum of 500 copies of each. The buyer does not want to exclude any marketplace or seller. Each copy must be in “Good” condition and shipping must be expedited. The maximum the buyer wants to pay is 70% of the listing price of each book as listed on marketplace A. The list price is set by the book's publisher (not the marketplace); it is the price printed on the book by the publisher. This means that if the list price of one book is $10, the buyer will only buy the book if it is being sold (by the seller) for $7 or less. This filter will be applied to all 250 titles. Taking this example further, the buyer may also specify a maximum price he will pay for a specific book or for all books. This may be helpful in case the list price of a particular book is not known. In this case, the maximum-price filter may take precedence over the percentage-of-listing filter. So, taking the example above, if the maximum price is specified at $6.50, and the book is being sold for $7, even though it is at 70% of the listing price, it will not be bought because it exceeds the maximum price filter of $6.50.

In another example, an individual book buyer wants to buy five books, one copy of each, and, in an effort to save money, does not want to pay more than 80% of the listing prices of any of the books at marketplace A. She wants to search all venues, wants each book to be “New,” and does not have any criteria regarding the sellers. She can create a buy list and book buying system of the present invention will find any books that meet this criteria. It will return this information to the buyer and she will then have the opportunity to complete transactions to meet her needs.

In another example, a book buyer, in an effort to save money, wants to buy used books but wants to ensure that the books that are purchased or shown to him for possible purchase are in good condition. To accomplish this, the user sets the condition filter to “Very good” or better. The user may also set the “bad keyword” filter to exclude listings that have those keywords in their descriptions on the marketplaces. For example, the keywords may be torn, water damaged, missing cover, missing pages, and the like. By setting these filters, including a maximum price, the buyer can find used books in very good condition and have those books purchased automatically, if that setting is selected.

In another example, a book buyer had a bad experience with a seller A, for example, the seller was slow to ship the book or the book was not in good condition. As a result, the buyer does not want to purchase any more books from him, even if a listing by the seller meets all other criteria. The buyer can set the “bad seller” filter to include seller A so that the system will filter out seller A's listings.

In a final example, a buyer wants to buy books but wants to purchase them at a very low price. She knows that it will be difficult to find listings of the books at the prices she wants. The buyer can set an option to make the system continuously search for books on the enabled venues. She can set the system to loop through her buying list continuously over time until the listings that match her price are found. In this manner, as soon as a listing that matches the criteria set by the buyer is on one of the enabled venues, the system will automatically buy it. The looping of the venue searching process can go on indefinitely until listings are found or the buyer manually stops the process. For example, the continuous loop search can go on for days, weeks, or longer, until the listings meeting the criteria are found. The buyer may also have set a maximum quantity for a book indicating that the buyer does not want the system to buy more than that quantity. The buyer can select an option to have her buying list purchases (which may be made automatically by the system) tracked, essentially maintaining a purchase history. By doing this, the system can keep a count of the number of books bought while the loop is executing and ensure that the count does not exceed the maximum quantity set by the buyer. When the maximum quantity is reached, the system will stop automatically buying any further copies of the particular book. When the maximum quantity for each book in the buying list has been bought, the continuous loop for that list will stop.

The loop execution feature allows a buyer to let the system continuously search all enabled venues for books that meet the buyer's criteria. Clearly, this would normally be a very time and labor intensive activity. With the present invention, the buyer does not have to do this search manually in order to find books meeting specific filters, not only for price but for condition, venue, and other criteria. The user can make the system more useful by adding the feature of checking the purchase history to ensure that only the right number of books is purchased. These are very useful features, especially for high-volume buyers who must make every effort to find the cheapest prices for books. There are numerous other filters that may be used. These are described below.

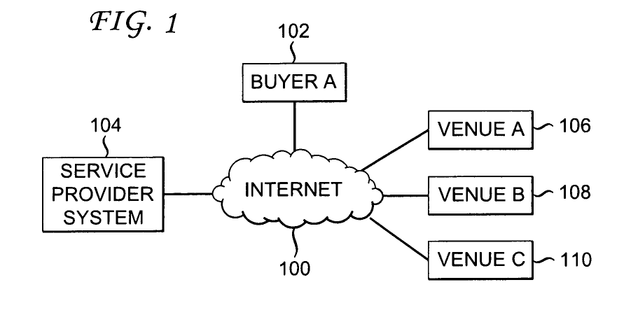

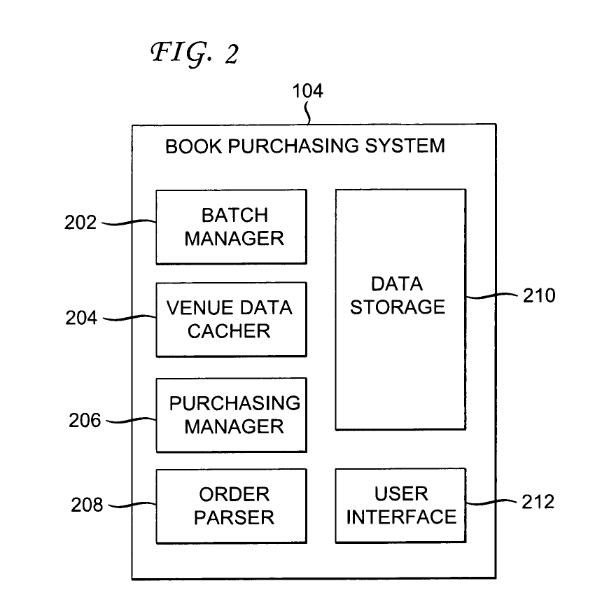

FIG. 1 is a network diagram showing a broad overview of the parties relevant to the present invention. Nearly all communications occur over Internet 100. A buyer 102, connected to Internet 100, logs on to the Web site of the book purchasing service provider (“service provider”) and establishes a session with a service provider system 104, also connected to Internet 100. It is service provider system 104 that executes the processes for implementing the various embodiments of the present invention. Components of system 104 are described in FIG. 2.

Various marketplace systems are also shown in FIG. 1, such as Venue 106, Venue 108, and Venue 110. As noted above, each marketplace or venue is a Web site where an outside party can purchase books (and other goods) either from the operator of the venue (e.g., Barnes and Noble Booksellers for bn.com) or from third-party sellers, such as individuals who meet certain criteria (set by the venue) and want to sell used or new copies of books. These are the primary parties involved in the inventive processes of the present invention.

Not shown in FIG. 1 are the third-party sellers. They transact sales through the venues and, for the purposes of this invention, do not interact directly with buyer 102. As noted above, buyer 102 can range from an individual to a chain bookstore or library system. For the purposes of describing the various embodiments, we assume the buyer is purchasing large volumes of multiple different books. It is also worth noting here that the service provider is not a wholesaler of books. Service provider 104 does not sell or buy books and does not accept payment from buyers or any other parties.

Buyer 102 logs into to the service provider's Web site. The first step she takes is creating a list of books she wants to buy, referred to as a buying list. She enters the titles or ISBNs of each of the books and the maximum quantity of each book she wants. She may then create filters regarding price, such as the maximum price she wants to pay or the maximum percentage of the list price. This is done for each book or ISBN. She proceeds with specifying other criteria or using her default or “global” filters. Once the filters have been set, a buying list is created by the service provider's book purchasing system 104.

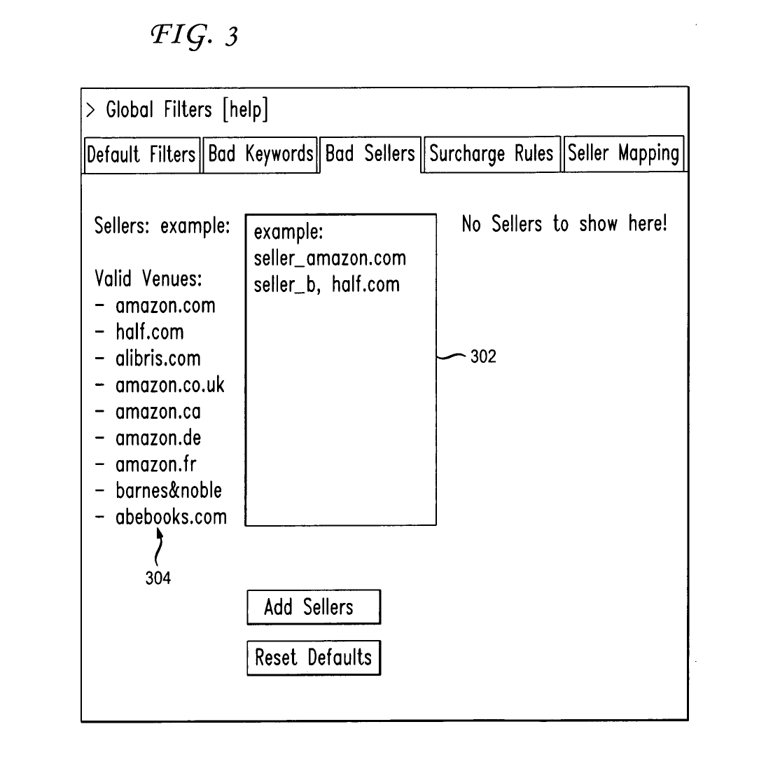

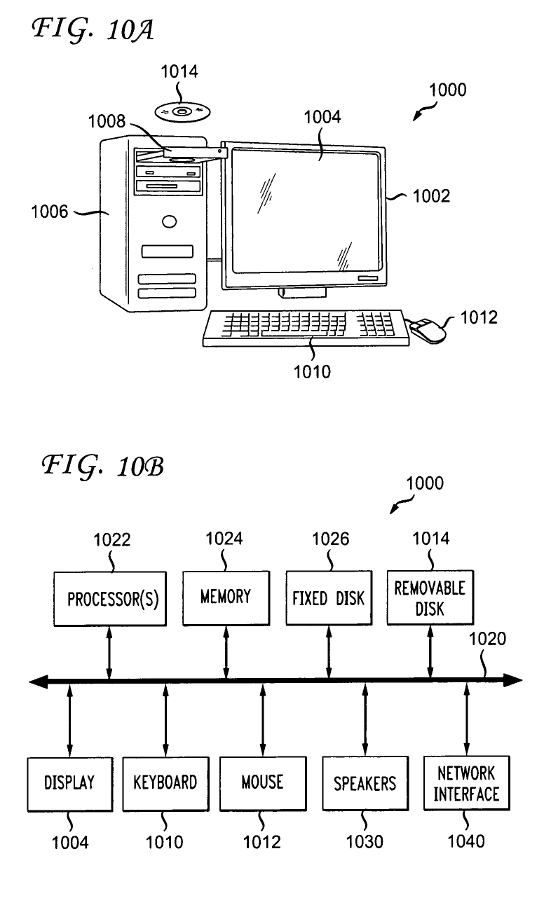

FIG. 2 is a block diagram showing various components and modules in service provider system 104 in accordance with one embodiment. System 104 may be composed of one or more server computers having access to the Internet, all of which are normally under the direct control of the service provider. In other embodiments, some modules, components or data storage facilities may be operated by a third-party but are still under the control of the service provider. Shown are a batch manager component (comprised of numerous batch managers) 202, a venue data cacher component (comprised of numerous venue data cachers) 204, a purchasing manager 206, and an order parser 208. Although only one module is shown for each, there may be multiple ones of each. For example, there may be eight batch managers in component 202, five venue data cachers in component 204, and so on. These are all illustrative names and are used only as descriptive examples for modules and components for executing functions and enabling the present invention. Each is in communication with a data storage component 210 which stores numerous tables and data needed for enabling the present invention, described in greater detail in FIG. 7. Also shown is a user interface component 212 for generating the various Web pages for use by buyers. Examples are shown in FIGS. 3, 4, and 9. Other generic computing components and modules not directly relevant to embodiments of the present invention but needed for execution and enablement are described in FIGS. 10A and 10B.

In the described embodiment, the buyer can set numerous filters, listed here, followed by the format of the input from the buyer. A book buyer can select no filters, one, or a combination of two or more filters when preparing a buying list, as described below. The filters include:
Seller Minimum Rating: a minimum percentage
Seller Minimum Feedback: a minimum number
Shipping (Show Only): checkboxes for Expedited and International
Minimum Condition: drop-down menu of standard condition terms
Hide Bad Sellers: Yes or No
Hide Bad Keywords: Yes or No
Enabled Venues: checklist of venues (marketplaces that have a relationship with the service provider)
Max Price Percent of List: text entry area (percentage); and
Skip Filtered Listings: Yes or No

Other examples of filters may be implemented depending on the needs of the buyers and the type of system the service provider wants to implement. In one example, the book buyer may also be a seller (not an unusual scenario for entities in the large-volume book transactions field) and in some cases may be trying to sell the same book that is being bought. In this case, the buyer can list itself as a “bad seller” by providing the buyer's name and the venue and this will exclude the buyer's own listings for the same books. Examples of bad keywords may be “water damage,” “international,” or “page torn.”

A user can also set global filters. Examples of global filters include: Bad Keywords, Bad Sellers, Surcharge Rules, Seller Mapping, and Default Filters. The Bad Sellers filter is shown in FIG. 3. A text entry area 302 allows a book buyer to enter the name of third-party sellers who the buyer does not want to have transactions with. The buyer can enter the name of the seller followed by the marketplace or venue where the seller is known (to the buyer) to sell books. In the example shown, a list of valid venues 304 is shown. Of course, this is only an example of some of the better known venues. A buyer may want to exclude a seller because of previous experience she or someone else has had, such as books not being in the condition promised or late deliveries. The same seller may have different names on different venues, which leads to another global filter, Seller Mapping.

A large third-party seller may list one book on multiple marketplaces. Thus, when the buyer looks at a listing of books (order list), described below, several of the listings may be from the same seller for the same book. As noted, the seller may use different names on different venues. To address the issue of these multiple listings by the same seller, one embodiment of the present invention includes a “seller mapping” database feature. The buyer, from experience, may know of seller identifiers across various venues that she knows correspond to the one seller.

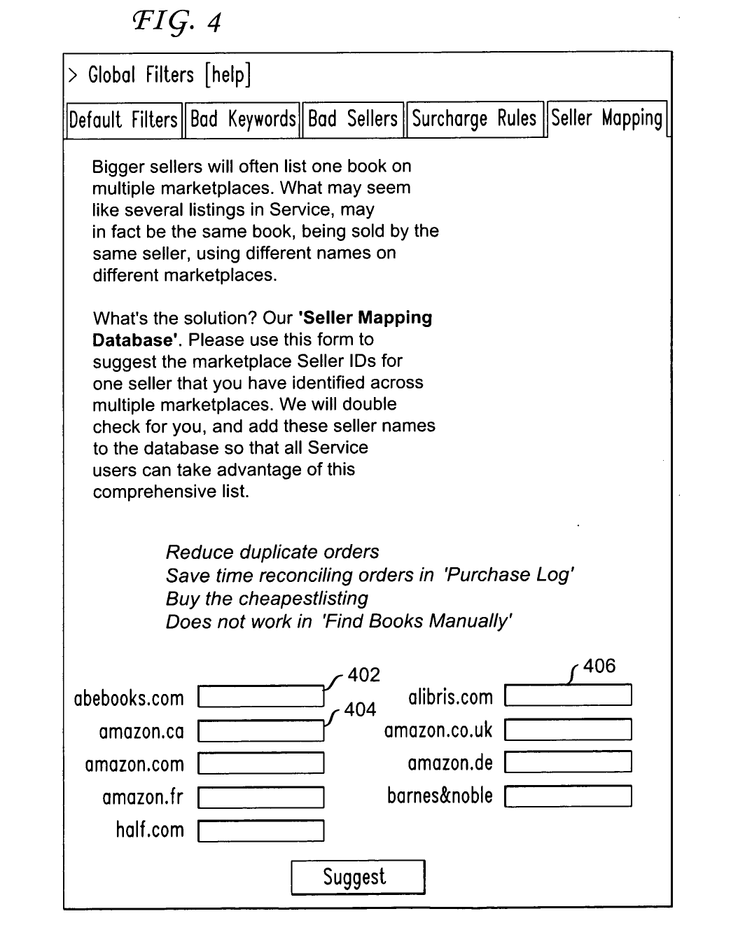

FIG. 4 shows a Seller Mapping user interface screen. She may enter the seller identifiers into a text areas 402, 404, 406, etc. next to each valid venue. The service provider may then use this information in filtering out what are essentially duplicative listings in an order list for the buyer. In one embodiment, the service provider takes the information and performs its own check to ensure its accuracy. If accurate, the information is stored in a database and used by the service provider so that it may be applied when compiling order lists for other buyers so the number of duplicative listings may be reduced for all buyers using the book purchasing service. It also saves time later in the process when the buyer reconciles orders in a purchase log or similar document and may also assist the buyer in easily locating the cheapest listing.

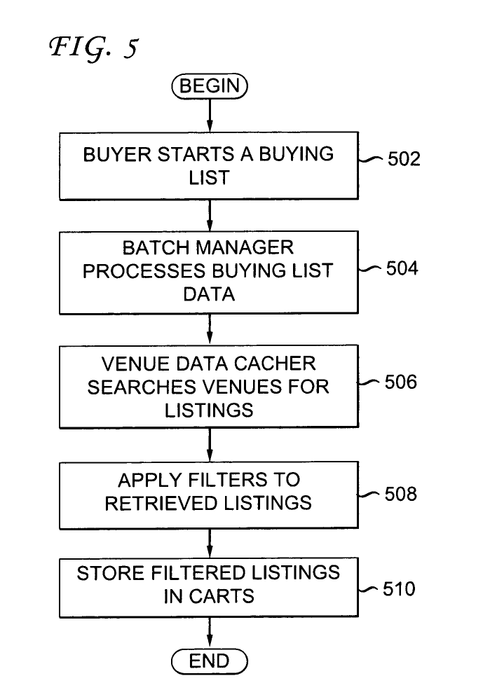

FIG. 5 is an overview flow diagram of a process for buying books using services from the service provider in accordance with one embodiment. A book buyer has already registered and logged on to the service provider system and has a list of books that she wants to purchase. She also has a profile which includes one or more global filters; that is, filters, which she wants to have applied to all purchases or, more specifically, searches for books performed by the service provider.

At step 502 the buyer creates a buying list. This is a list of books including the maximum quantity and the maximum price. She may also enter other filters that she wants applied to this specific transaction. These filters may be entered using a buying list editor. The buyer may specify which venues she wants searched for the books or may specify bad sellers or minimum conditions. Some of these filters, as noted, may be set in the buyer's profile as global filters. However, the buyer may override a global filter by indicating a filter through the buying list editor. For example, a global filter may be to search all venues but the buyer may indicate that certain venues not be searched for a particular buying list. At step 504 the batch manager module 202 receives the buy information from the buyer and begins processing this information. A buying list is created in an edit list editor by the buyer in the buyer's browser. The buying list is stored in the database. It should be noted that the batch manager does not create the buying list; it processes the buying list when the buyer starts creation of the list, as described below. Batch manager module 202 is able to accept data from multiple users at the same time since multiple buyers may be using the system and entering buying criteria data simultaneously.

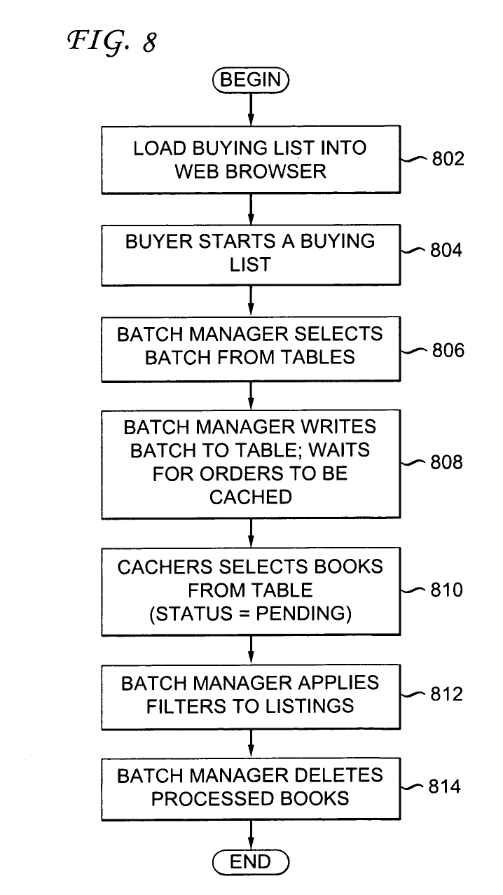

When the buyer starts a list from his browser, a batch is created in a batches_index_table. A batch is represented by a record in this table and represents a buying list processing status. The batch manager detects new batches for a specific buying list (‘blist_id’ field in the batches_index_table, described below) that has a ‘status’ field equal to ‘processing’. The batch manager starts to process the buying list. While doing that, the batch manager updates the batches_index table (a ‘progress’ field, and a ‘status’ field when it is completed, as described below). It will also perform all the other actions described below at step 804 of FIG. 8. For example, the batch manager will then fill a processing_lists table with all the books that need to be processed and will start to periodically move some of the books to an orders_locked table from where they are fed to the cachers.

At step 506 a venue data cacher 204 takes a buying list from the database and searches the marketplaces for listings of that book. In one embodiment, the cachers do not work directly with the buying lists. The cachers are fed by the batch managers. The cachers cache the listings for the ISBNs that the batch managers input to them. The cachers select those ISBNs from the orders_locked table which have a ‘status’ field equal to ‘pending’ and puts them in the orders_cached table. Each venue typically has an API that may be used by third parties, such as the service provider, to search the venue's listings. The venue data cacher 204 passes the ISBNs to the APIs which use the ISBN as a key to perform searches on the Web sites. If a venue does not have an API, techniques known in the art, such as page scrapping, can be used to retrieve listings using the ISBN as a key.

Once the search is done, the information retrieved is stored in multiple tables, described below. The volume of data resulting from the search is typically much larger than the original buying list. There may be thousands of listings for a particular ISBN. A popular book may be sold by thousands of different sellers across numerous venues. The data retrieved includes the listing price, seller's name, rating, description, shipping information, and other data. In the described embodiment, the criteria or filters have not been applied yet, so all listings for that ISBN are retrieved and stored. In another embodiment, the enabled venue filter is applied and only listings from the marketplaces that the buyer wants queried are retrieved and stored. For example, in this embodiment, if the buyer has a global filter for enabled venues that has only Amazon.com and Half.com indicated, only listings from those two marketplaces will be stored. In another embodiment, only listings meeting the “condition” filter may be retrieved and stored by the venue data cacher 204. For example, only listings that list a book as “New” or another condition, may be returned. This may be desirable to reduce the volume of data that the service provider has to store. However, in the described embodiment, the venue data cacher 204 performs the first step of retrieving all the listings for each ISBN in the buying list. When an ISBN has been cached, the cacher changes its status in the orders_cached table from pending to cached. Descriptions of the tables that store the buying lists and the data retrieved by the pricing cacher (i.e., the listings) after searching the venues are described in detail below.

At step 508 the filters are applied to the listings retrieved at step 506 by the venue data cacher 204. The filters are applied by the batch manager 202. The filters may be retrieved from the buying list. Once they are applied to the listings data, which can be described as the “raw data,” many of the listings may be filtered out, depending on the number of filters set by the buyer. For example, the buyer may have only enabled one venue or set a very low price, which may filter out a vast majority of the listings. At step 510 the filtered data is stored in another set of tables, which may be described as storing the buyer's “carts.” Once the filtered data is stored in one or more carts, the venue data tables which were used to store all the listings retrieved from the venues are emptied, primarily because there is now no further use of that data and because the volume of that data can be very large. In one embodiment, each individual cart has only one ISBN, although the listings for that ISBN can be from one or more venues. Thus, a cart may have 250 listings, all for the same ISBN, from four different venues. A single cart can also contain multiple listings for multiple ISBNs. All the listings for all the ISBNs in a buying list may be placed in the same cart. In one embodiment, each buying list has only one cart.

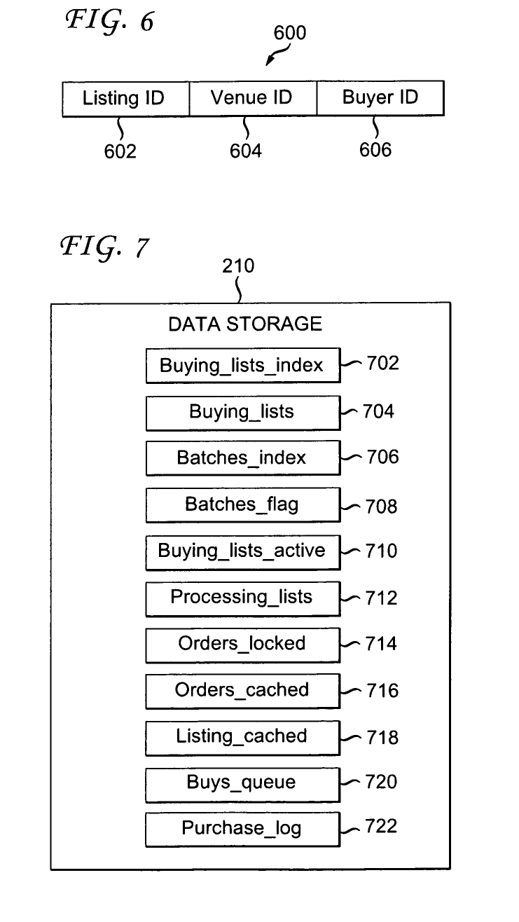

Each listing of a book has a listing identifier. For example, if a book is listed 15 times on marketplace A, 23 times on marketplace B, and twice on marketplace C, it will have a total of 40 listing IDs, each ID assigned by the marketplace and each one unique. The service provider uses this listing ID, together with a venue ID (which the service provider assigns and uses to identify the marketplace), and a book buyer ID (also assigned by the service provider to the book buyer, to create its own unique identifier for a listing. This unique identifier is shown in FIG. 6. A unique identifier 600 is comprised of a listing ID 602, a venue ID 604, and a buyer ID 606. The listing ID 602 may vary in length since each venue may have a different format.

Carts are created and populated by batch manager 204. In another embodiment, they may be created and populated by a manual buying machine. When the buyer starts a buying list, he can choose between two different ways to start the list: Auto or Manual (Auto is the default). The manual buying machine is used when he chooses Manual, or when he uses a ‘Direct Lookup Feature’ to search for only one ISBN without having to create a list. When the buyer chooses Manual, the system will not apply the filters and will not select the good listings automatically. Instead, the book purchasing system will show a Web page to the buyer where he can see all the listings for one ISBN, edit the filters ‘on the fly’ or on the spot and manually select the listings he wants to add to his cart. This will be repeated for all the ISBNs in the list. The batch record in the batches_index table and in a batches_flag table, both described below, linked to this manual buying operation has a ‘flag’ field set to Manual instead of Auto. The service provider's Web server manages this process and communicates with the database. The batch managers are not involved (operations and logic are the same).

In one embodiment, after listings are added to the cart, the book purchasing system will try to buy them. In the book purchasing system, each venue has a different instance of a script, created by the service provider. These different versions of the script are part of and executed by purchasing manager 206. Each instance of the script is specialized for each venue. At step 512, a cart is processed by manager 206 if a flag for the cart indicates ‘pending’. The appropriate script is applied to each entry in the cart. For example, if an entry is from marketplace A, purchasing manager 206 ensures that the instance of the script for marketplace A is applied to the entry.

In one embodiment, the buyer can use the manual buying machine to add listings to his cart. In another embodiment, the cart may be populated using an “auto-process.” In both cases, the buyer sees his cart and is able to revise listings or to manually buy the books in the cart. In another embodiment, the cart may be described as abstract or virtual, in the sense that the buyer does not see the cart or its contents. When the buyer executes a buying list, all the listings selected are written to a cart (implemented by a buys_queue table, described below) and an order placer module will buy the books automatically. In this same embodiment, if the buyer chooses to use the “manual buying machine,” all the listings he selects from the cart will be bought by the order placer module in the same way, that is, automatically. In this case, the buyer still does not see the cart; he only sees the listings which he can select from using the manual buying machine interface in his browser.

The function of the order placer scripts is to make the actual purchase at the venue for that particular listing. Thus, when the order placer scripts are applied to all the listings or entries in the cart, purchases for each of the listings are made at the venues. Manager 206 examines the results of each script execution to see if the purchase transaction was successful, rejected, or whether some other type of error occurred.

In one embodiment, the order placer check all carts that are pending at regular intervals, such as every n seconds. The order placer checks the carts to see if there are any purchases it needs to make, and it will run the specific script, based on the marketplace, it needs in order to buy them. For example, if there are carts with pending entries for marketplace B, a specific script for that marketplace will execute those listings, thereby completing the transaction for that listing at marketplace B. Carts may be created continuously in the system and the scripts in manager 206 check carts as they are created and apply themselves to the listings. In another embodiment, the buyer selects the listings in the cart which he wants to buy and fulfils his purchasing needs manually. For example, a cart may have 20 listings for one ISBN, totaling 700 copies of the book. However, the buyer may only want 150 copies of the book. He can select the listings from the cart to purchase only the 150 copies. In this scenario, he would presumably select the listings at the cheapest price. In another embodiment, the system can automatically select the listings and buy the books to meet the buyer's needs. In this manner, the buyer is able to satisfy his book buying needs by only buying books that meet his criteria. In another embodiment, the buyer can manually check the listings that were automatically selected by the system, the buyer can revise or change some of the listings that were chosen by the system. In this case the system will show the buyer all the offers or listings available for the ISBN the buyer wants to change, and he will be able to override the listings chosen by the system. If the buyer does not act on the listings in the cart soon after the cart is created and shown to the buyer, some listings may not be available if they were purchased by other buyers. By having the service provider system do the extensive and continuous searching of the various venues and provide the buyer with the results in real time, the buyer is able to essentially pick from the best listings, allowing him to “pick the low-hanging fruit” or find the most economical offerings each time he makes a purchase.

After a purchase has been completed at a venue by the order parser module, a purchase ID or order ID is sent to the buyer at a time after the purchase; it is typically not sent immediately by the venue. An order parser script parses all e-mails from venues to obtain an order ID. The order ID may then be compared with a purchase number or ID created by the service provider after the purchase has been made. In another embodiment, the script may scrape a ‘new order’ page at the venue and get the order ID. This scrapping may be done at regular intervals to get the order ID so it can be matched with the purchase number created by the service provider. In another embodiment, when completing the purchasing process, the order placer adds a number generated by the book purchasing system (labeled as REF#) to the buyer's shipping address. When he receives the book he can match this auto-generated REF# with the system order record to easily identify the purchase, to mark it as “received” and to check that the book received is the correct one. This is very useful when the system is used to place numerous orders for a single buyer. In another embodiment the buyer can use the cart_id number created by the system which is associated with his cart to manually add the cart_id to his address for better tracking of his orders. In another embodiment the buyer can also personalize his cart_id number and add a Custom Post Office (PO) name to it.

The order parser script updates the order record in a purchase_log table. For example, the order parser script adds the venue order identifier to the order record. In one embodiment, the order parser may send preset e-mails to the sellers that the buyer has previously configured in the Web interface.

As described above, there are numerous tables used in implementing various embodiments of the present invention. FIG. 7 is a block diagram showing data storage component 210 storing tables relevant to the implementation of the book purchasing system of the present invention. In one embodiment, there are several tables used to implement the book purchasing system of the present invention. They are listed here and described in detail below: buying_lists_index 702, buying_lists 704, batches_index 706, batches_flag 708, buying_lists_active 710, processing_lists 712, orders_locked 714, orders_cached 716, listings_cached 718, buys_queue 720, and purchase_log 722. Other embodiments may have more or fewer tables in their implementations and the tables described below and their names are simply illustrative of one embodiment.

Starting at the beginning of the process, a buying list created by a buyer is represented in the database by two tables. One of the tables is a buying_lists_index table which identifies the buying lists currently in the database. In one embodiment, it has the following fields: owner_id, blist_id, blist_name, date_created, date_modified, and hidden. It also has the following fields relating to the filter options or criteria set for a particular buying list: seller_min_rate, seller_minfb, ship_options, min_condition, hide_sellers, hide_keywords, default_qty, enabled_venues, skip_notprofit, and list_percent.

Beginning with the first set of fields in the buying_lists_index table, owner_id is the service provider's internal user identifier for the buyer who created a buy list. Blist_id is an internal unique numeric identifier for a buying list that is generated automatically by the service provider system. Blist_name is the name of the list as given by the buyer and date_created is the date the buy list was created by the buyer. Date_modified was the last date the buy list was modified by the buyer. The hidden field is used by the system for a direct look-up feature. If the buyer is using this feature, it is set to “yes,” otherwise it is set to “no.”

The second set of fields in the table relate to the filter options for a buying list. Seller_min_rate is the minimum seller rating set by the buyer and seller_min_fb is the minimum seller feedback number. A buyer will not buy any books from a seller who does not meet these minimum requirements. Ship_options indicates the speed or type of shipping as set by the buyer (e.g., standard or expedited). Min_condition holds a numeric value that corresponds to the minimum condition the buyer will accept for the books purchased. For example, 4=NEW, 3=LIKE NEW, 2=VERY GOOD, 1=GOOD, and 0=ACCEPTABLE. Hide_sellers can be “yes” or “no” and indicates whether the buyer wants to filter listings by using his bad_sellers list in the global filters. Similarly, hide_keywords can be “yes” or “no” and indicates if the buyer wants to filter listings using his bad_keywords list in the global filters. Default_qty is a numeric value indicating the number of books the system will buy if the buying list does not have a specific maximum quantity chosen by the buyer. Enabled_venues is a list of marketplaces where the buyer wants to search for books. Skip_notprofit can be “yes” or “no” and indicates whether a feature of the manual buying machine where a book is skipped entirely if there are no listings that match filter criteria is enabled or disabled. List_percent is a field that can be set by a buyer to indicate to the system whether to consider only items that have a price equal to or lower than x % of the item list price.

A second table in the system is the buying_lists table. Each record or entry in this table corresponds to each book (ISBN) that is in the buyer's buying list. If the buying list has 13 books, a buying_lists table for that list has 13 records. A uid field stores a unique numeric identifier that identifies a book or ISBN. It is generated automatically by the system. Another field, owner_id is the same as described above in the buying_lists_index table, an identifier for the buyer within the service provider system. The user identified by the value in this field has the book corresponding to the record in his buying list. A blist_id field is the same as described above in the buying_lists_index table. It stores a unique identifier of the buying list that contains the book corresponding to the record. A product_id field stores the ISBN-13 number for the book identified by the record. A price field stores the maximum price that the buyer, identified by owner_id, is willing to pay for the book, identified uniquely by uid or product_id. A last_processed field stores the time when the book was last processed by the batch manager. That is, the last time that the batch manager selected some listings for that ISBN in that list. A qty field stores the maximum quantity of copies of the book that the buyer is willing to buy for the book.

The next category of tables are used in the second stage of the process. When the buying process for a buying list begins, a batch is created for the buying list. A table referred to as batches_index stores records identifying batches which indicates the processing status of a buying list. The first field in this table is batch_id which stores a unique identifier used to identify a batch and is generated automatically by the system. A flag field that can store either “manual” or “auto” depending on whether the buying process is going through a manual buying machine (by the buyer) or is being done automatically by the system. Two other fields are owner_id and blist_id which are the same as described above. Another field is a time created field which stores the time that the batch was created. A time_started field stores the time when the system began processing the batch. A last_time_processed field stores the last (or most recent) time that the system processed the batch. A time_completed field stores the time that the system completed processing the batch. A status field contains the current status of the batch: “processing”, “completed”, or “pending.” Pending indicates that the batch is scheduled to be processed. In one embodiment, a buyer can only have one batch processing at a time. A total_qty field stores the total number of books in the buying list that the batch needs to process. A progress field stores the total number of books in the buying list that the batch has processed. A loop_buy field is “0” if the buyer chooses to not have the list be searched or executed in a continuous loop. If he does want to execute the continuous loop feature, the loop_buy field is “1”. IF the batch is going through a loop, the value in this field will be incremented by one after each loop to keep a running count of how many cycles or loops were executed. A use_history field may be “yes” if the buyer chose to factor in past purchasing history into this batch or “no” if otherwise. This field informs the batch manager if the buyer wants to consider the history of purchases made relating to the buying list or not, for example, when the system is performing continuous loop execution.

Another table referred to as batches_flag is used for processing a particular batch. Each record in this table corresponds to each batch. Some embodiments of the present invention may not need to implement this table. It may be used to improve efficiency of the system. It has fields that have been described above: owner_id, batch_id, blist_id, and flag. The flag field stores the flag value of the batch from the batches_index table.

Another table that may be used in some embodiments for improving efficiency may be referred to as a buying_lists_active table. It has the same fields as the buying_lists table, except for uid, which the buying_lists_active table does not have. Each record in the buying_lists_active table corresponds to a particular buying list, identified by the blist_id (the internal identifier for the list being processed by the batch manager).

Another table is a processing_lists table. This table has one record for each book and contains all the books that need to be processed or searched for at the venues. It has fields for owner_id, blist_id, and product_id, each described above with respect to the other tables. It also has a pl_qty field which stores the maximum number of copies of a book that the buyer is willing to buy of the book. This value can be different from the value in the buying_lists table (called qty). This is so because if the buyer is using a “consider buying history” option in the global filters, the value in pl_qty will be the quantity that the buyer still needs to buy to reach the initially specified quantity for the book, specified in the qty field, based on past purchases.

In the next stage of the process, the batch manager 204 manages the batches. Batch manager module 204 (comprised of multiple batch managers) determines how it will execute based on internal logic, such as speed and volume limits. For example, no buyer may execute or purchase more than 10,000 ISBNs in one hour. After the batch manager module 204 manages the batches, the next stage begins utilizing another table called orders_locked. The batch manager checks how many books it has already processed for the cacher component. Every batch manager has a limit of the number of books it is allowed to select at one time. If there are empty spots in the cacher, the batch manager selects additional books from the processing_lists table. The batch manager writes those books into the orders_locked table. Essentially, the batch manager can only feed the cacher a limited number of books at one time.

The orders_locked table has an owner_id field, a product_id field (storing the ISBN-13 of the book), and a blist_id field, all as described above. A time_locked field stores the time when the book corresponding to the record was inserted into the orders_locked table. A node_id field stores an identifier of a specific batch manager, such as a batch_manager server, that locked the corresponding book. This field is useful because a batch manager may use it to determine how many books it is inputting to the cacher.

In the next stage, the order_cacher scripts make a query to determine which items need to be cached from the orders_locked table. It can select up to a certain number of books, for example, 30. The order_cacher scripts writes the books to another table referred to as orders_cached table. The records written to this table by the order_cacher scripts are designated as status “pending.” The orders_cached table has a product_id field as described above. A time_cached field stores the time when the book was successfully cached in the orders_cached table. A status field indicates whether an entry is “pending” or “cached.”

At this stage, the order_cacher will spawn or create children threads, for example, one thread for each marketplace. These threads collect listing information from each venue. This listing information is written to a table referred to as listings_cached. When the children threads are done executing at their respective venues, the cacher sets the status field in the orders_cached table to cached.

While the scripts are executing, the batch manager waits for books to be in the cached status. When a book is in the cached status, the batch manager reads the listings_cached table and selects the listings that are still available for buying after all the buying list filters and global filters have been applied and puts them in a cart. The batch manager writes these books to a table referred to as buys_queue. Each buys_queue table corresponds to a cart which contains book listings from one buying list.

This table has an uid field that stores a unique identifier for the buying list. This number is auto-generated by the book purchasing system and is essentially an internal unique identifier for each row in the buys_queue table. There are also fields for owner_id (for the book buyer, generated by the system) and blist_id. There is also a cart_id field that stores a unique and system-generated number that identifies the cart where all the available listings are stored. In one embodiment, each buying list has one cart. A product_id field contains the ISBN-13 of the book. A time_queued field contains the time when the book was added to the cart. A listing_id field contains the listing identifier from the venue for the book. This is used by the venue to identify this listing in the marketplace and is unique for every listing. A buy_venue_id field contains a numeric value that identifies the marketplace where the listing was listed. A status field is a flag used to track the status of the book. It indicates whether the buyer excluded it during checkout or if the buyer purchases it. Another field, listing_id_list is used to store additional seller information used to generate links to a seller profile page. A seller name field contains the seller's name as provided on the venue site. A seller_state field contains the location of the book.

A total_cost field contains the price of the book and an original_cost field contains the price of the book in the currency used by the venue (e.g., pounds sterling for Amazon.uk). There is also a shipping_cost field which contains the shipping cost. A sub_condition field contains the condition of the book, such as N=new, LN=like new, VG=very good, G=good, and A=acceptable. A details field may be used to stored a book description as provided by the seller. An intl_type field may be “yes” if the purchase is placed outside the United States, and “no” otherwise. An quantity field stores the number of copies of the book added to the cart and a title field stores the title of the book. After cart processing is complete, the batch manager deletes the processed records from the orders_locked and processing_lists tables. The batch manager is informed that the batch has completed one cycle. A cycle means that the all the books that were given to the cachers for a batch or list have been processed, so it is time to cache the remaining books for the buying list, or to mark the batch as ‘completed’ if all the books in the list have been processed. If the batch is not completed, the process inputs new books into the cacher. This will be repeated until the batch is complete.

All the books that go through the checkout process at the venues are recorded in a table referred to as purchase_log. The buyer can check on the service provider Web interface all the books that were checked out (purchased), search through them by setting some criteria (e.g., date, list name, ISBN, seller name and so on), add personal notes or add personal records to track refund requests (although they are not made by the book purchasing system, the buyer can keep notes about them in the system). The purchase_log table may have some of the same fields as the buys_queue table, plus some additional fields. A qty_received field stores the quantity of books the buyer marked as received for a particular transaction or order. A loop_cycle field stores the number of loop cycles of the buying list when the book was checked out at the venue. A refund_requested field stores the date when the buyer requested a refund for this order, a refund_date field stores the date when the buyer received the refund for the order, and a refund_amount field which stored the amount of the refund. A date_received field stores the date when the buyer marked an order as received from the Web interface. A venue_order_id field stores the identifier for the order from the marketplace. This field is updated by the order parser. A ship_method field indicates whether shipping is “standard” or “expedited,” also updated by the order parser. A deadline field stores a date that is generated by the book purchasing system to suggest a time limit to the buyer. If the buyer has not marked this order as received by this suggested time, the system adds this order to the missing order panel for the buyer to review. The Web interface of the book purchasing system also offers tools for the buyers to mark books as received, to track missing orders or refund requests. These features and aspects are described in U.S. Provisional Patent Application No. 61/237,269, titled “Automated Volume Book Purchasing System and Method,” incorporated by reference herein in its entirety and for all purposes.

With respect to the continuous loop execution and the purchase history feature, when the books are checked out, they are stored in the purchase_log table. Before writing to the processing_lists table, the batch manager checks the quantities that the buyer wanted to purchase (from the buying_lists table) and the number the buyer has already bought (from the purchase_log table) for the list. The batch manager writes the quantities the buyer still needs to purchase in the pl_qty field in the processing_lists table, for every ISBN.

FIG. 8 is a flow diagram showing the steps of creating and fulfilling a buying list as executed by the service provider's system in accordance with one embodiment. It describes in more detail some of the steps or stages mentioned above. At step 802 a buying list is loaded in a Web page on the buyer's computer. This is done using the buying_lists_index and buying_lists tables. The buyer begins inserting books into a buying list. At step 804 the buyer executes or starts a buying list by instructing the system to find the books it has saved in a buying list (performed at step 802). In the buying process of step 804, several sub-steps occur. A batch is created for the buying list. As described above, a batch represents the status of processing of an active buying list in the book purchasing system. An entry for the batch is written to the batches_index table. A record may also be written to the batches_flag table to improve performance. A record may also be written to the buying_lists_active table for the batch that was created for the buying list. The system then writes records to the processing_lists table where one record in this table corresponds to one book. Thus, if a buyer creates a buying list that contains five books (each of which the buyer may want to buy thousands of copies), five records will be written to the processing_lists table.

At step 806 a batch manager begins managing the batch by selecting the batch from the batches_index table. In one embodiment, the batch manager selects the oldest batch in the table. The batch manager applies specific rules or logic when selecting and managing the batch, such as processing limits and speed limits. At step 808 the batch manager writes a record to the orders_locked table for the batch. It will then wait for the individual orders in the batch to be cached and then written to the orders_cached table. The batch may check how many books it has already written for the cachers (each batch may have a limit of the number of individual books it can select at one time). If there is space or empty spots in the cacher, the batch selects more items from the processing_lists table.

At step 810 the cacher selects books from the orders_locked table. As described above, the order_cacher scripts perform a query to determine which books need to be cached from the order_locked table. In this step, records for each selected book are written to the orders_cached table where their status is ‘pending’. A thread is spawned for each venue and each thread writes records to the listings_cached table for listings found at the venue. At this stage the status of the books in the orders_cached table is updated to ‘cached’.

At step 812 the batch manager applies filters to the cached listings. During this step, records for the listings that pass through the filters are written to the buys_queue table, which is the implementation of a cart for the buyer. At step 814 the batch manager deletes the processed books from the processing_lists and orders_locked tables. This is repeated until the batch is completed.

The system implements other tables for storing relevant data. As described above, the listings_cached table stores listings from a venue. Each record in the table represents a listing. Many of the fields in the listings_cached table are described above. They include product_id, venue, price, original_price, shipping_cost, condition (e.g., N, LN, VG, G, and A), listing_id, seller_id, and location.

The listings_cached table also has a seller_url_id field and an s_id field. These two fields are used to store additional identifiers related to the seller used on the particular venue or marketplace. They may be used to generate one or more URLs that link to a seller profile page, if the seller has one. A rating field stores a rating of the seller as provided on the venue. This is typically a value from 0% to 100%. If there is no seller rating available, the value may be “N/A”. A feedback field contains the number of feedback comments that were used or contributed to creating the seller rating on the marketplace. For example, a seller rating may be 78% and 12 comments or feedback instances contributed to this rating. A ship_method field contains the fastest available shipping method used by the seller (e.g., expedited or standard) and a ship_intl field indicates if the seller ships internationally. A details field contains text describing the book as provided by the seller on venue. A qty field (different from those described above) stores the number of copies of a book that the seller has available for sale on the venue. An original_price field stores the price of the book in the currency used by the venue (e.g., GBP for Amazon.co.uk) and a currency field stores the currency of the value in the original_price field.

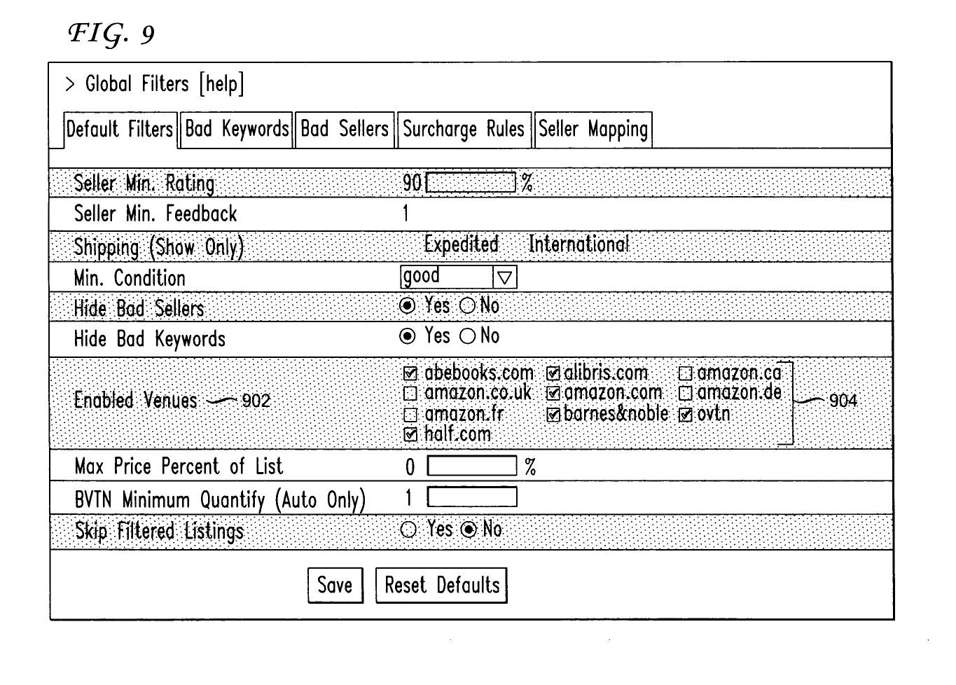

FIG. 9 is a screen diagram of a Global Filters screen that a buyer can use to set filters that may be applied to all buying lists started by the buyer, unless overridden by filters in a buying list editor. In particular, it shows an Enabled Venues filter 902 where the buyer can select which venues or marketplaces he wants searched for possible listings. Shown are checkboxes 904 that the buyer can use to make his selection. The venues shown in 904 are simply examples of some marketplaces. As is known to a person skilled in the art, there are many other venues that may be listed. In one embodiment, the venues listed are those venues (or Web sites) with which the service provider has a partnership. However, a partnership or any type of relationship is not necessarily needed for a venue to be listed in 904.

FIGS. 10A and 10B illustrate a computing system 1000 suitable for implementing embodiments of the present invention. FIG. 10A shows one possible physical implementation of the computing system for implementing the service provider's system 104. The internal components of the computing system may have many physical forms including an integrated circuit, a printed circuit board, a personal computer or a server computer, a mobile computing device, an Internet appliance, and the like. In one embodiment, computing system 1000 includes a monitor 1002, a display 1004, a housing 1006, a disk drive 1008, a keyboard 1010 and a mouse 1012. Disk 1014 is a computer-readable medium used to transfer data to and from computer system 1000. Other computer-readable media may include USB memory devices and various types of memory chips, sticks, and cards.

FIG. 10B is an example of a block diagram for computing system 1000. Attached to system bus 1020 are a wide variety of subsystems. Processor(s) 1022 (also referred to as central processing units, or CPUs) are coupled to storage devices including memory 1024. Memory 1024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1026 is also coupled bi-directionally to CPU 1022; it provides additional data storage capacity and may also include any of the computer-readable media described below. Fixed disk 1026 may be used to store programs, data and the like and is typically a secondary storage medium (such as a hard disk) that is slower than primary storage. It will be appreciated that the information retained within fixed disk 1026, may, in appropriate cases, be incorporated in standard fashion as virtual memory in memory 1024. Removable disk 1014 may take the form of any of the computer-readable media described below.

CPU 1022 is also coupled to a variety of input/output devices such as display 1004, keyboard 1010, mouse 1012 and speakers 1030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1022 optionally may be coupled to another computer or telecommunications network using network interface 1040. With such a network interface, it is contemplated that the CPU might receive information from the network, or might output information to the network in the course of performing the above-described method steps. Furthermore, method embodiments of the present invention may execute solely upon CPU 1022 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A method of enabling a book purchasing transaction, the method comprising:
receiving at least one book identifier identifying a book and at least one filter value;
creating a buying list containing the book identifier;
querying at least one venue for listings corresponding to the book identifier;
retrieving said listings;
applying at least one filter to said retrieved listings;
displaying the filtered listings to a buyer, enabling the buyer to select one or more filtered listings to satisfy the book purchasing transaction; and
enabling completion of the book purchasing transaction at the venue.

2. A method as recited in claim 1 further comprising:
continuously querying the at least one venue for listings corresponding to the book identifier.

3. A method as recited in claim 2 further comprising:
examining a quantity of books purchased value to determine whether to terminate said continuous querying of the at least one venue for listings.

4. A method as recited in claim 1 further comprising:
enabling a buyer to select one or more venues from which purchases are made.

5. A method as recited in claim 1 further comprising:
processing buyer input relating to the book purchasing transaction.

6. A method as recited in claim 1 further comprising:
storing the filtered listings in one or more carts.

7. A method as recited in claim 1 further comprising:
enabling a buyer to set a first set of filters; and
enabling the buyer to override said first set of filters with a second set of filters for a specific buying list.

8. A method as recited in claim 1 further comprising:
including an automatically generated reference number to a shipping address of the buyer, such that the buyer is able to identify the book purchasing transaction and change a status of the transaction to received.

9. A method as recited in claim 1 wherein a buyer shipping address is modified such that the address includes a cart identifier.

10. A method as recited in claim 9 wherein the card identifier is personalized by the buyer.

11. A method of enabling a book purchasing transaction, the method comprising:
receiving at least one book identifier identifying a book and at least one filter value;
creating a buying list containing the book identifier;
querying at least one venue for listings corresponding to the book identifier;
retrieving said listings;
applying at least one filter to said retrieved listings; and
enabling the automatic purchase of the book at the venue on behalf of the buyer.

12. A method as recited in claim 11 further comprising:
continuously querying the at least one venue for listings corresponding to the book identifier.

13. A method as recited in claim 12 further comprising:
examining a quantity of books purchased value to determine whether to terminate said continuous querying of the at least one venue for listings.

14. A method as recited in claim 11 further comprising:
enabling a buyer to select one or more venues from which purchases are made.

15. A method as recited in claim 11 further comprising:
enabling a buyer to set a first set of filters; and
enabling the buyer to override said first set of filters with a second set of filters for a specific buying list.

16. A system for enabling a book buying transaction over a computer network, the system comprising:
a processor;
a network interface;
a batch manager module;
a venue data cacher module;
a purchasing manager;
an order parser; and
a data storage component for storing book purchasing transaction data organized in a plurality of database tables.
